(19) United States
(12) Patent Application Publication
(10) Pub. No.: US 2024/0296972 A1
(43) Pub. Date: Sep. 5, 2024

(54) CABLE, CABLE ASSEMBLY, AND COMMUNICATIONS SYSTEM

(71) Applicant: HUAWEI TECHNOLOGIES CO., LTD., Shenzhen,Guangdong (CN)

(72) Inventors: Wanxing Wang, Dongguan (CN); Tien Chieh SU, Shanghai (CN); Dongdong Shen, Shanghai (CN)

(73) Assignee: HUAWEI TECHNOLOGIES CO., LTD., Shenzhen,Guangdong (CN)

(21) Appl. No.: 18/262,563

(22) PCT Filed: Jan. 18, 2022
(86) PCT No.: PCT/CN2022/072480

§ 371 Date: Jul. 21, 2023

(30) Foreign Application Priority Data
Jan. 21, 2021 (CN) 202110084095.X
Mar. 2, 2021 (CN) 202110232499.9

(51) Int. Cl. H01B 7/18; H01B 7/00; H01B 11/10; H01B 11/20

(52) U.S. Cl. CPC H01B 7/18; H01B 7/0045; H01B 11/1091; H01B 11/20

(57) ABSTRACT

This application discloses a cable, a cable assembly, and a communications system. The cable includes a power wire, a signal wire, a ground wire, a wrapping layer, a coaxial wire, and a protective layer. The signal wire is used to transmit a low-speed signal. The coaxial wire is used to transmit a high-speed signal. The power wire, the signal wire, and the ground wire are wrapped in the wrapping layer. The coaxial wire is on an outer side of the wrapping layer. The wrapping layer and the coaxial wire are wrapped in the protective layer.

This application is a national stage of International Application No. PCT/CN2022/072480, filed on Jan. 18, 2022, which claims priority to Chinese Patent Application No. 202110232499.9, filed on Mar. 2, 2021 and Chinese Patent Application No. 202110084095.X, filed on Jan. 21, 2021. All the aforementioned applications are hereby incorporated by reference in their entireties.

### TECHNICAL FIELD

This application relates to the field of communications technologies, and in particular, to a cable, a cable assembly, and a communications system.

### BACKGROUND

In recent years, the large-screen market has advanced into a period of rapid growth. People's demand for large screens is not only for common television viewing but also for high-definition visual enjoyment and more diversified functions. Therefore, there is a higher requirement on a transmission capability of a cable connecting a large screen to a set-top box (set-top box, STB, also referred to as a digital video converter box). However, because of an inappropriately-designed structure of a conventional cable, the conventional cable has relatively poor performance of electromagnetic radiation resistance, and cannot satisfy a large-screen transmission requirement.

### SUMMARY

This application provides a cable, a cable assembly, and a communications system with better performance of electromagnetic radiation resistance.

According to a first aspect, this application provides a cable. The cable includes a power wire, a signal wire, a ground wire, a wrapping layer, a coaxial wire, and a protective layer. The signal wire is used to transmit a low-speed signal, and the coaxial wire is used to transmit a high-speed signal.

The power wire, the signal wire, and the ground wire are wrapped in the wrapping layer. The coaxial wire is on an outer side of the wrapping layer. The wrapping layer and the coaxial wire are wrapped in the protective layer.

It can be understood that the coaxial wire is separated from the power wire by using the wrapping layer. Therefore, when a signal is transmitted through the cable, transmission performance of the coaxial wire is unlikely to be affected by the power wire. In this way, the cable can still supply electric power and transmit a high-speed signal, and performance of electromagnetic radiation resistance of the cable can be greatly improved.

In addition, the coaxial wire is separated from the signal wire by using the wrapping layer. Therefore, when a signal is transmitted through the cable, signal crosstalk is unlikely to happen between the signal wire and the coaxial wire, and performance of crosstalk resistance of the cable is improved.

Further, the coaxial wire is a type of signal wire with an electromagnetic shield layer. The coaxial wire has a relatively strong capability of crosstalk resistance. In this way, performance of crosstalk resistance of the cable can also be improved.

The cable in this embodiment can further solve some problems of a structure of a conventional cable.

First, in this application, the power wire, the signal wire, and the ground wire are wrapped in the wrapping layer. As there are just a few types of wires, the power wire, the signal wire, and the ground wire relatively easily form a full circle, and the power wire, the signal wire, and the ground wire can be assembled together more compactly and solidly, facilitating implementing a design of a smaller outer diameter of the cable.

Second, compared with a solution in which the power wire, the signal wire, and the ground wire are mixed up with the coaxial wire for assembly, this embodiment provides the coaxial wire that can be assembled separately. In an assembly process, a problem that various wires move relative to each other, the coaxial wire cannot be easily wrapped in the protective layer of the cable, and assembly of the cable is more difficult because the coaxial wire and the power wire, the signal wire, and the ground wire are mixed up does not emerge. Therefore, the cable in this embodiment relatively has high manufacturability.

In addition, because the coaxial wire can be relatively easily wrapped in the protective layer of the cable, the cable can more easily form a full round circle. In this case, a thickness of the protective layer of the cable can be more easily controlled. The cable can be assembled more solidly and compactly. A minimum value of the outer diameter of the cable can reach 6 millimeters or even less.

In a possible implementation, the wrapping layer is insulating paper, PET, PTFE, or a wave absorbing material. It can be understood that the insulating paper, PET, PTFE, or the wave absorbing material is relatively inexpensive. Therefore, costs of the wrapping layer do not greatly increase costs of the cable while the wrapping layer can achieve the foregoing effects. Especially when the wrapping layer is the insulating paper, compared with total costs of the cable, the costs of the wrapping layer can be almost negligible.

In a possible implementation, the power wire includes a power inner conductor and a power insulation layer. A lateral surface of the power inner conductor is wrapped in the power insulation layer. A diameter of the power inner conductor satisfies 23 AWG. A material of the power insulation layer is FEP. It can be understood that the power wire can implement a 5A current-carrying function. The power wire has relatively good current-carrying functionality.

In a possible implementation, the cable further includes an electronic wire. The electronic wire is wrapped in the wrapping layer, and the electronic wire is used for transmitting a low-speed signal or transmitting electric power, or is used for grounding, or is reserved. Therefore, there are many types of electronic wires of the cable for wide usage.

In a possible implementation, the signal wire is a sideband link (sideband link, SL). The SL can implement high-speed link initialization, high-bandwidth digital content protection (high-bandwidth digital content protection, HDCP) handshake, capability obtaining, audio return, and the like.

In a possible implementation, the cable further includes a USB data wire set. The USB data wire set is wrapped in the wrapping layer. The USB data wire set is used to transmit a low-speed signal. Therefore, there are many types of electronic wires of the cable for wide usage.

In a possible implementation, there are a plurality of coaxial wires. The plurality of coaxial wires are disposed around the wrapping layer and form a ring.

It can be understood that, when there are a plurality of coaxial wires, a transmission bandwidth of the coaxial wires can be relatively greatly increased, so that the cable is facilitated to transmit a high-speed signal requiring a relatively large transmission bandwidth.

In addition, when the plurality of coaxial wires around the wrapping layer form a ring, the coaxial wires and the wrapping layer can be assembled more compactly. Further, the cable can more easily form a full round circle. The thickness of the protective layer of the cable can be more easily controlled.

In a possible implementation, the cable includes a shield layer. The shield layer is between the protective layer and the wrapping layer, the shield layer is disposed around the wrapping layer. The wrapping layer and the coaxial wires are wrapped in the protective layer with the shield layer. The shield layer is used to shield a signal outside the cable.

It can be understood that the shield layer is disposed between the coaxial wires and the protective layer. Therefore, the shield layer can be used to fix the coaxial wires to ensure reliability of the cable. In addition, the shield layer can shield the signal outside the cable to greatly improve a capability of crosstalk resistance of the cable.

In a possible implementation, the shield layer includes a substrate and a plurality of shield wires, the substrate is disposed around the wrapping layer, and the wrapping layer and the coaxial wires are wrapped in the protective layer with the substrate. The substrate has an outer ring surface. The outer ring surface of the substrate is a surface that is of the substrate and that faces the protective layer. The plurality of shield wires are disposed on the outer ring surface of the substrate. In this way, the shield layer has a higher capability of fixing the coaxial wires, and the cable has higher reliability. In addition, the shield layer has a higher capability of shielding the signal outside the cable.

In a possible implementation, the substrate is aluminum foil, and the shield wires are copper wires. Therefore, costs of the shield layer do not greatly increase costs of the cable while the shield layer can achieve the foregoing effects. Compared with total costs of the cable, the costs of the shield layer can even be almost negligible.

In a possible implementation, the signal wire includes a signal inner conductor and a signal insulation layer. A lateral surface of the signal inner conductor of the signal wire is wrapped in the signal insulation layer of the signal wire. A structure of the signal wire is relatively uncomplicated with relatively low costs.

In a possible implementation, the coaxial wire includes at least one core wire, a coaxial wire insulation layer, a coaxial wire shield layer, and a rubber sheath layer. The core wire is wrapped in the coaxial wire insulation layer. A lateral surface of the coaxial wire insulation layer is wrapped in the coaxial wire shield layer. The coaxial wire shield layer is wrapped in the rubber sheath layer. In this way, a structure of the coaxial wire is relatively uncomplicated and does not greatly increase the costs of the cable easily.

In a possible implementation, a material of the protective layer is TPU or TPE. In this way, the protective layer has relatively great strength and relatively high excellent bending resistance.

According to a second aspect, this application provides a cable assembly. The cable assembly includes a first circuit board, a second circuit board, a first male connector, a second male connector, and the cable described above.

The cable includes a first end and a second end. The first end of the cable is fixedly connected to the first circuit board and is electrically connected to the first circuit board. The second end of the cable is fixedly connected to the second circuit board and is electrically connected to the second circuit board.

The first male connector is fixedly connected to the first circuit board, and is electrically connected to the first end of the cable through the first circuit board. The first male connector is used to fit into a first female connector of a first device. The second male connector is fixedly connected to the second circuit board, and is electrically connected to the second end of the cable through the second circuit board. The second male connector is used to fit into a second female connector of a second device.

It can be understood that, in this application, the cable has relatively high performance of electromagnetic resistance and high performance of crosstalk resistance, and the cable can still transmit a high-speed signal. When the cable is applied to the cable assembly, the cable assembly also has relatively high performance of electromagnetic resistance and high performance of crosstalk resistance, and the cable assembly can still transmit a high-speed signal.

In addition, the first circuit board and the first male connector are disposed at the first end of the cable, the second circuit board and the second male connector are disposed at the second end of the cable, so that the cable assembly not only can transmit electric power, but also can transmit a high-speed signal.

In a possible implementation, the cable assembly further includes a first protective sheath and a second protective sheath. The first protective sheath is sleeved on a part of the first male connector, the first circuit board, and the first end of the cable. The second protective sheath is sleeved on a part of the second male connector, the second circuit board, and the second end of the cable. It can be understood that the first protective sheath can protect the part of the first male connector, the first circuit board, and the first end of the cable. The second protective sheath can protect the part of the second male connector, the second circuit board, and the second end of the cable.

According to a third aspect, this application provides a communications system. The communications system includes a first device, a second device, and the cable described above. The cable is electrically connected to the first device. The cable is electrically connected to the second device.

It can be understood that, in this application, the cable has relatively high performance of electromagnetic resistance and high performance of crosstalk resistance, and the cable can still transmit a high-speed signal. When the cable is applied to the communications system, the communications system also has relatively high performance of electromagnetic resistance and high performance of crosstalk resistance, and the communications system can still transmit a high-speed signal.

For example, when the first device is powered on, the first device may transmit electric power to the second device through the cable, so that the second device starts working. In this way, the second device does not need a plug, a connector, or another component and is electrically connected to an external power supply directly, so that the second device can be saved from having a component for an electrical connection to the external power supply, and a structure of the second device is simplified. In addition, the first device may transmit a high-speed signal to the second device through the cable. The second device can implement high-definition display and high-quality audio play.

In a possible implementation, the first device is a set-top box. The second device is a screen. The first device transmits electric power and a signal to the second device through the cable.

It can be understood that, when the set-top box is powered on, the set-top box may transmit electric power to the screen through the cable to power on the screen. In this way, the screen does not need a plug, a connector, or another component and is electrically connected to an external power supply directly, so that the screen can be saved from having a component for an electrical connection to the external power supply, a structure of the screen is simplified, and an increase of a thickness of the screen because of the component disposed in the screen for an electrical connection to the external power supply is avoided. That is, it can be facilitated to implement a thin design of the screen, and this is a better manner of design for a wall with a limited space.

In a possible implementation, the cable includes a first end and a second end. The communications system further includes a first circuit board, a second circuit board, a first male connector, and a second male connector. The first end of the cable is fixedly connected to the first circuit board and is electrically connected to the first circuit board. The second end of the cable is fixedly connected to the second circuit board and is electrically connected to the second circuit board.

The first male connector is fixedly connected to the first circuit board, and is electrically connected to the first end of the cable through the first circuit board. The second male connector is fixedly connected to the second circuit board, and is electrically connected to the second end of the cable through the second circuit board.

The first device is provided with a first female connector. The second device is provided with a second female connector. The first male connector fits into the first female connector. The second male connector fits into the second female connector.

It can be understood that the first circuit board and the first male connector are disposed at the first end of the cable, the second circuit board and the second male connector are disposed at the second end of the cable, so that the communications system not only can transmit electric power, but also can transmit a high-speed signal.

In a possible implementation, the communications system further includes a first protective sheath and a second protective sheath. The first protective sheath is sleeved on a part of the first male connector, the first circuit board, and the first end of the cable. The second protective sheath is sleeved on a part of the second male connector, the second circuit board, and the second end of the cable. It can be understood that the first protective sheath can protect the part of the first male connector, the first circuit board, and the first end of the cable. The second protective sheath can protect the part of the second male connector, the second circuit board, and the second end of the cable.

According to a fourth aspect, this application provides a communications system. The communications system includes a device and the cable described above. The cable is electrically connected to the device.

It can be understood that, in this application, the cable has relatively high performance of electromagnetic resistance and high performance of crosstalk resistance, and the cable can still transmit a high-speed signal. When the cable is applied to the communications system, the communications system also has relatively high performance of electromagnetic resistance and high performance of crosstalk resistance, and the communications system can still transmit a high-speed signal.

In a possible implementation, the device is a screen or a set-top box. It can be understood that the cable and the screen form a whole independent product. Alternatively, the cable and the set-top box form a whole independent product.

In a possible implementation, the cable includes a first end and a second end. The communications system further includes a first circuit board, a second circuit board, a first male connector, and a second male connector.

The first end of the cable is fixedly connected to the first circuit board and is electrically connected to the first circuit board. The second end of the cable is fixedly connected to the second circuit board and is electrically connected to the second circuit board. The first male connector is fixedly connected to the first circuit board, and is electrically connected to the first end of the cable through the first circuit board. The second male connector is fixedly connected to the second circuit board, and is electrically connected to the second end of the cable through the second circuit board.

The cable is electrically connected to the device by using the first male connector, or the cable is electrically connected to the device by using the second male connector.

It can be understood that the first circuit board and the first male connector are disposed at the first end of the cable, the second circuit board and the second male connector are disposed at the second end of the cable, so that the communications system not only can transmit electric power, but also can transmit a high-speed signal.

In a possible implementation, the communications system further includes a first protective sheath and a second protective sheath. The first protective sheath is sleeved on a part of the first male connector, the first circuit board, and the first end of the cable. The second protective sheath is sleeved on a part of the second male connector, the second circuit board, and the second end of the cable. It can be understood that the first protective sheath can protect the part of the first male connector, the first circuit board, and the first end of the cable. The second protective sheath can protect the part of the second male connector, the second circuit board, and the second end of the cable.

According to a fifth aspect, this application provides a cable assembly. The cable assembly includes a first circuit board, a second circuit board, a first female connector, a second female connector, and the cable described above.

The cable includes a first end and a second end. The first end of the cable is fixedly connected to the first circuit board and is electrically connected to the first circuit board. The second end of the cable is fixedly connected to the second circuit board and is electrically connected to the second circuit board.

The first female connector is fixedly connected to the first circuit board, and is electrically connected to the first end of the cable through the first circuit board. The first female connector is used to fit into a first male connector of a first device. The second female connector is fixedly connected to the second circuit board, and is electrically connected to the second end of the cable through the second circuit board. The second female connector is used to fit into a second male connector of a second device.

It can be understood that, in this application, the cable has relatively high performance of electromagnetic resistance and high performance of crosstalk resistance, and the cable can still transmit a high-speed signal. When the cable is applied to the cable assembly, the cable assembly also has relatively high performance of electromagnetic resistance and high performance of crosstalk resistance, and the cable assembly can still transmit a high-speed signal.

In addition, the first circuit board and the first female connector are disposed at the first end of the cable, the second circuit board and the second female connector are disposed at the second end of the cable, so that the cable assembly not only can transmit electric power, but also can transmit a high-speed signal.

In a possible implementation, the cable assembly further includes a first protective sheath and a second protective sheath. The first protective sheath is sleeved on a part of the first female connector, the first circuit board, and the first end of the cable. The second protective sheath is sleeved on a part of the second female connector, the second circuit board, and the second end of the cable. It can be understood that the first protective sheath can protect the part of the first female connector, the first circuit board, and the first end of the cable. The second protective sheath can protect the part of the second female connector, the second circuit board, and the second end of the cable.

According to a sixth aspect, this application provides a cable. The cable includes a power wire, a signal wire, an electronic wire, a USB data wire set, a ground wire, a wrapping layer, a plurality of coaxial wires, a shield layer, and a protective layer. Both the signal wire and the USB data wire set are used to transmit a low-speed signal. The signal wire is a sideband link. The electronic wire is used for transmitting a low-speed signal or transmitting electric power, or is used for grounding, or is reserved. The plurality of coaxial wires are used to transmit a high-speed signal. A maximum value of a transmission bandwidth of the plurality of coaxial wires is greater than or equal to 128 Gbps.

The power wire, the signal wire, the electronic wire, the USB data wire set, and the ground wire are wrapped in the wrapping layer. The wrapping layer is insulating paper, PET, PTFE, or a wave absorbing material.

The plurality of coaxial wires are on an outer side of the wrapping layer, and the plurality of coaxial wires are disposed around the wrapping layer and form a ring.

The shield layer includes a substrate and a plurality of shield wires. The plurality of coaxial wires are wrapped in the substrate. The substrate has an outer ring surface. The outer ring surface of the substrate is a surface that is of the substrate and that is away from the wrapping layer. The plurality of shield wires are disposed on the outer ring surface of the substrate. The substrate is aluminum foil. The shield wires are copper wires.

The plurality of shield wires are wrapped in the protective layer. A material of the protective layer is TPU or TPE.

It can be understood that, in this aspect, the maximum value of the transmission bandwidth of the plurality of coaxial wires is greater than or equal to 128 Gbps. The power wire of the cable has especially obvious interference on the coaxial wires, and consequently performance of electromagnetic radiation resistance of the cable is relatively poor. In this case, although the coaxial wires can transmit a high-speed signal, because performance of electromagnetic radiation resistance is poor, the coaxial wires still cannot be used for signal transmission between two devices. In the cable in this embodiment, the coaxial wires are separated from the power wire by using the wrapping layer. Therefore, when a signal is transmitted through the cable, transmission performance of the coaxial wires is unlikely to be affected by the power wire. In this way, the cable can still supply electric power and transmit a high-speed signal, and performance of electromagnetic radiation resistance of the cable can be greatly improved.

Further, the cable in this embodiment has a relatively high capability of crosstalk resistance. Details are provided below:

In this embodiment, the coaxial wires are separated from the signal wire, the electronic wire, and the USB data wire set by using the wrapping layer. Therefore, when a signal is transmitted through the cable, signal crosstalk is unlikely to happen between the signal wire, the electronic wire, and the USB data wire set and the coaxial wires, and performance of crosstalk resistance of the cable is improved.

Further, the coaxial wires are a type of signal wires with an electromagnetic shield layer. The coaxial wires have a relatively strong capability of crosstalk resistance. In this way, performance of crosstalk resistance of the cable can also be improved.

The cable in this embodiment can further solve some problems of a structure of a conventional cable.

First, in this application, the power wire, the signal wire, the electronic wire, the USB data wire set, and the ground wire are wrapped in the wrapping layer. As there are just a few types of wires, the power wire, the signal wire, the electronic wire, the USB data wire set, and the ground wire relatively easily form a full circle, and the power wire, the signal wire, the electronic wire, the USB data wire set, and the ground wire can be assembled together more compactly and solidly, facilitating implementing a design of a smaller outer diameter of the cable.

Second, compared with a solution in which the power wire, the signal wire, the electronic wire, the USB data wire set, and the ground wire are mixed up with the coaxial wires for assembly, this embodiment provides the coaxial wires that can be assembled separately. In an assembly process, a problem that various wires move relative to each other, the coaxial wires cannot be easily wrapped in the protective layer of the cable, and assembly of the cable is more difficult because the coaxial wires and the power wire, the signal wire, the electronic wire, the USB data wire set, and the ground wire are mixed up does not emerge. Therefore, the cable in this embodiment relatively has high manufacturability.

In addition, because the coaxial wires can be relatively easily wrapped in the protective layer of the cable, the cable can more easily form a full round circle. In this case, a thickness of the protective layer of the cable can be more easily controlled. The cable can be assembled more solidly and compactly. A minimum value of the outer diameter of the cable can reach 6 millimeters or even less.

In addition, the insulating paper, PET, PTFE, or the wave absorbing material is relatively inexpensive. Therefore, costs of the wrapping layer do not greatly increase costs of the cable while the wrapping layer can achieve the foregoing effects. Especially when the wrapping layer is the insulating paper, compared with total costs of the cable, the costs of the wrapping layer can be almost negligible.

Further, when the material of the protective layer is TPU or TPE, the protective layer has relatively great strength and relatively high excellent bending resistance.

### BRIEF DESCRIPTION OF DRAWINGS

To describe technical solutions in embodiments of this application or in the background, the accompanying drawings for describing embodiments of this application or the background are the briefly described below.

FIG. 1 is a schematic diagram of a structure of a communications system according to an embodiment of this application;

FIG. 2 is a schematic diagram of a structure of a cable assembly in the communications system shown in FIG. 1:

FIG. 3 is a schematic exploded diagram of a cable of the cable assembly shown in FIG. 2:

FIG. 4 is a schematic sectional diagram of a cable, cut along a line A-A, in the cable assembly shown in FIG. 2:

FIG. 5 is a schematic diagram of a partial structure of an inner wire group shown in FIG. 3 at an angle:

FIG. 6 is a schematic diagram of a partial structure of an inner wire group shown in FIG. 3 at another angle:

FIG. 7 is a schematic diagram of a partial structure of the cable shown in FIG. 2:

FIG. 8 is a schematic exploded diagram of a coaxial wire shown in FIG. 4:

FIG. 9 is a schematic diagram of a partial structure of a coaxial wire shown in FIG. 4:

FIG. 10 is a schematic diagram of a structure of a shield layer of the cable shown in FIG. 3:

FIG. 11 is a schematic diagram of a partial structure of the cable shown in FIG. 2; and

FIG. 12 is a schematic diagram of a partial structure of the cable shown in FIG. 2.

### DESCRIPTION OF EMBODIMENTS

To facilitate understanding of a communications system provided in embodiments of this application, related terms used in this application are explained.

W refers to watt and is the unit of power.

A refers to ampere and is the unit of electric current.

V refers to voltage and is the unit of voltage.

Gbps is also referred to as a transmission bandwidth and is the unit for measuring an overall data transmission capability of a transmission device. A transmission rate is 1,000 megabits or 1,000 megabytes per second (that is, 1 Gbps).

Crosstalk: Crosstalk refers to an unwanted coupling effect of a signal transferred from one network to another network.

Loss: Loss refers to energy loss during signal transfer along a transmission line and may occur in five manners, that is, medium loss, wire loss, outward radiation, impedance mismatch reflection, outward coupling to a neighboring network. The loss is usually represented and measured by a parameter S.

Ground: A simplest transmission line includes two wires of specific lengths. One of the wires is used as a signal path for signal transmission, and the other wire is used as a return path for transmission of a returned current of the signal. The return path is usually referred to as “ground”.

UL 758 Standard: The standard sets out general specifications for materials of cables and wires used for electric appliances and is applied to only wiring of appliances or equipment within manufactory of the appliances or equipment.

UL 1581 Standard: The standard is the reference standard for electrical wires, cables, and flexible cords, contains specific details of conductors, insulation, jackets and other coverings, and further contains specific details of sample preparation, specimen selection, conditioning, and methods of measurement and calculation.

Embodiments of this application are described below with reference to the accompanying drawings in embodiments of this application.

In descriptions of embodiments of this application, it should be noted that, unless otherwise clearly specified and limited, the term “connection” should be understood in a broad sense. For example, a “connection” may be a detachable connection, a nondetachable connection, may be a direct connection, or may be an indirect connection through an intermediary. “Fixedly connected to” means a connection to each other with a changeless relative position relationship after the connection. The terms of locality such as “inner” and “outer” used in embodiments of this application are descriptions with reference to orientations in the accompanying drawings, and the terms of locality that are used are intended for better and clearer description and understanding of embodiments of this application, but do not indicate or imply that a described apparatus or element needs to have a particular orientation or be configured and operated in a particular orientation, and therefore cannot be understood as a limitation on embodiments of this application. A “plurality of” means at least two.

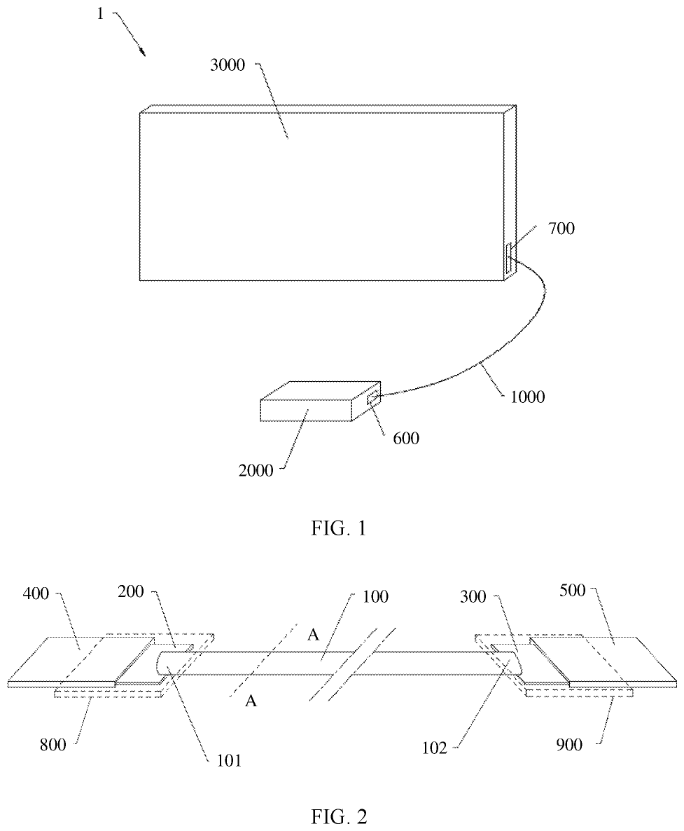

Refer to FIG. 1. FIG. 1 is a schematic diagram of a structure of a communications system 1 according to an embodiment of this application. The communications system 1 includes a cable assembly 1000, a first device 2000, and a second device 3000. The cable assembly 1000 connects the first device 2000 to the second device 3000. It should be noted that FIG. 1 and related accompanying drawings below show only some components included in the communications system 1 as examples. Actual shapes, actual sizes, actual positions, and actual structures of these components are not limited to FIG. 1 and various accompanying drawings below:

In this embodiment, the first device 2000 may be a set-top box (set top box. STB, also referred to as a digital video converter box), a host of a computer, a projector, an interactive internet protocol television (internet protocol television. IPTV) box, an over-the-top (over-the-top. OTT) terminal, or another device. The second device 3000 may be a display device, for example, a screen, a tablet computer (tablet computer), a laptop computer (laptop computer), a personal computer, a notebook computer, a vehicle-mounted device, a wearable device, augmented reality (augmented reality: AR) glasses, an AR helmet, virtual reality (virtual reality. VR) glasses, or a VR helmet. In the embodiment shown in FIG. 1, an example in which the first device 2000 is a set-top box and the second device 3000 is a screen is used for description.

When the first device 2000 is powered on (for example, a plug of the first device 2000 is inserted into an external power supply), the first device 2000 may transmit electric power to the second device 3000 through the cable assembly 1000, so that the second device 3000 starts working. In this way, the second device 3000 does not need a plug, a connector, or another component and is electrically connected to an external power supply directly, so that the second device 3000 can be saved from having a component for an electrical connection to the external power supply, and a structure of the second device 3000 is simplified. In addition, the first device 2000 may transmit a signal (for example, an image signal or an audio signal) to the second device 3000 through the cable assembly 1000, so that the second device 3000 performs a display or audio play function. The cable assembly 1000 has an “all-in-one” function. It can be understood that, in this embodiment, transmission of electric power and a signal is unidirectional.

In this embodiment, high-power electric power may be transmitted to the second device 3000 through the cable assembly 1000. A power of the electric power ranges from 300 W to 720 W or even higher. In this way, the cable assembly 1000 can supply high-power electric power to the second device 3000 that has a relatively large area or a plurality of display screens. In another embodiment, low-power electric power may alternatively be transmitted to the second device 3000 through the cable assembly 1000. In this way, the cable assembly 1000 can supply low-power electric power to the second device 3000 that has a relatively small area or a relatively small quantity of display screens.

In addition, the first device 2000 may further transmit a high-speed signal to the second device 3000 through the cable assembly 1000, so that the second device 3000 implements high-definition display or high-quality audio play. A rate of transmitting the high-speed signal may reach 128 Gbps or even higher. In this way, the cable assembly 1000 can implement transmission of an image signal of 4K, 8K, or higher than 8K. When the second device 3000 receives the image signal, the second device 3000 may implement high-definition display. 4K and 8K refer to resolutions, a resolution of 4K is 3840 pixels×2160 pixels, and a resolution of 8K is 7680 pixels×4320 pixels. In another embodiment, the first device 2000 may alternatively transmit a signal of another speed to the second device 3000 through the cable assembly 1000.

It should be noted that, how the cable assembly 1000 in this embodiment supplies high-power electric power and transmits a signal at a high speed is described in detail below with reference to related accompanying drawings. Details are not provided herein again.

In another embodiment, the first device 2000 and the second device 3000 may alternatively each be a router, a server, a network switch, or another device. When the first device 2000 is powered on (for example, a plug of the first device 2000 is inserted into an external power supply), the first device 2000 may transmit electric power to the second device 3000 through the cable assembly 1000. When the second device 3000 is powered on (for example, a plug of the second device 3000 is inserted into an external power supply), the second device 3000 may also transmit electric power to the first device 2000 through the cable assembly 1000. In addition, the cable assembly 1000 may be further used for signal transmission between the first device 2000 and the second device 3000. Specifically, the first device 2000 may transmit a signal to the second device 3000 through the cable assembly 1000. The second device 3000 may also transmit a signal to the first device 2000 through the cable assembly 1000. It can be understood that, in this embodiment, transmission of electric power and a signal is bidirectional.

A connection relationship between the cable assembly 1000, the first device 2000, and the second device 3000 is described above. Several application scenarios of the communications system 1 are described in detail below with reference to related accompanying drawings.

In a first application scenario, refer to FIG. 1 again. The first device 2000 is a set-top box. The second device 3000 is a screen. For example, the screen may be fixed to a wall. In this way, the screen can effectively utilize space of the wall, to improve space utilization of the wall. For mounting of a screen that has a relatively large area or a plurality of screens, utilization of the space of the wall is more important.

The cable assembly 1000 connects the set-top box to the screen. When the set-top box is powered on, the set-top box may transmit electric power to the screen through the cable assembly 1000 to power on the screen. In this way, the screen does not need a plug, a connector, or another component and is electrically connected to an external power supply directly, so that the screen can be saved from having a component for an electrical connection to the external power supply, a structure of the screen is simplified, and an increase of a thickness of the screen because of the component disposed in the screen for an electrical connection to the external power supply is avoided. That is, it can be facilitated to implement a thin design of the screen, and this is a better manner of design for a wall with a limited space.

In a second application scenario, the first device 2000 is a host of a computer. The second device 3000 is a display screen of the computer. For example, the display screen of the computer may be placed on a desk.

The cable assembly 1000 connects the host of the computer to the display screen of the computer. When the host of the computer is powered on, the host of the computer may transmit electric power to the display screen of the computer through the cable assembly 1000 to power on the display screen of the computer. In this way, the display screen of the computer does not need a plug, a connector, or another component and is electrically connected to an external power supply directly, so that the display screen of the computer can be saved from having a component for a connection to the external power supply, a structure of the display screen of the computer is simplified, and an increase of a thickness of the display screen of the computer because of the component disposed in the display screen of the computer for an electrical connection to the external power supply is avoided. That is, it can be facilitated to implement a thin design of the display screen of the computer, and this is a better manner of design for a desk with a limited space.

In a third application scenario, the first device 2000 is a host of a computer. The second device 3000 is VR glasses.

The cable assembly 1000 connects the host of the computer to the VR glasses. The host of the computer can transmit a high-speed signal to the VR glasses through the cable assembly 1000. Therefore, the VR glasses can display high-definition virtual scenes relatively smoothly. User experience is good. Therefore, in an application field of VR, the cable assembly 1000 is also a better choice.

Refer to FIG. 2. FIG. 2 is a schematic diagram of a structure of the cable assembly 1000 in the communications system 1 shown in FIG. 1. The cable assembly 1000 includes a cable 100, a first circuit board 200, a second circuit board 300, a first male connector 400, a second male connector 500, a first protective sheath 800, and a second protective sheath 900. It should be noted that, to clearly show a relationship between the first circuit board 200 and the first male connector 400 and a relationship between the second circuit board 300 and the second male connector 500, the first protective sheath 800 and the second protective sheath 900 are shown in FIG. 2 by using dashed lines.

The first circuit board 200 and the second circuit board 300 may be rigid circuit boards, may be flexible circuit boards, or may be rigid-flex circuit boards. The first circuit board 200 and the second circuit board 300 may be FR-4 dielectric boards, may be Rogers (Rogers) dielectric boards, or may be hybrid dielectric boards of FR-4 and Rogers. Herein, FR-4 is a grade designation for flame retardant material, and a Rogers dielectric board is a high-frequency board.

The cable 100 includes a first end 101 and a second end 102. The first end 101 of the cable 100 is fixedly connected to the first circuit board 200 and is electrically connected to the first circuit board 200. For example, the first end 101 of the cable 100 may be fixedly connected to the first circuit board 200 by welding.

In addition, the second end 102 of the cable 100 is fixedly connected to the second circuit board 300 and is electrically connected to the second circuit board 300. For example, the second end 102 of the cable 100 may be fixedly connected to the second circuit board 300 by welding.

Refer to FIG. 2 again. The first male connector 400 is fixedly connected to the first circuit board 200 and is electrically connected to the first circuit board 200. In this case, the first male connector 400 may be electrically connected to the first end 101 of the cable 100 through the first circuit board 200. The second male connector 500 is fixedly connected to the second circuit board 300 and is electrically connected to the second circuit board 300. In this case, the second male connector 500 may be electrically connected to the second end 102 of the cable 100 through the second circuit board 300.

With reference to FIG. 1 and FIG. 2, the first device 2000 is provided with a first female connector 600. The second device 3000 is provided with a second female connector 700. In this way, the first male connector 400 of the cable assembly 1000 fits into the first female connector 600 of the first device 2000, and the second male connector 500 of the cable assembly 1000 fits into the second female connector 700 of the second device 3000, to implement an electrical connection between the first device 2000 and the second device 3000.

In another embodiment, the first female connector 600 and the first male connector 400 may exchange positions. In this case, the first female connector 600 is fixedly connected to the first circuit board 200 and is electrically connected to the first circuit board 200. The first device 2000 is provided with the first male connector 400.

In another embodiment, the second female connector 700 and the second male connector 500 may exchange positions. In this case, the second female connector 700 is fixedly connected to the second circuit board 300 and is electrically connected to the second circuit board 300. The second device 3000 is provided with the second male connector 500.

Refer to FIG. 2 again. The first protective sheath 800 is sleeved on a part of the first male connector 400, the first circuit board 200, and a part of the first end 101 of the cable 100. The first protective sheath 800 may be used to protect the first male connector 400, the first circuit board 200, and the part of the first end 101 of the cable 100. In this way, a connection between the first male connector 400 and the first circuit board 200 is more stable, and a connection between the first circuit board 200 and the first end 101 of the cable 100 is more stable.

In addition, the second protective sheath 900 is sleeved on a part of the second male connector 500, the second circuit board 300, and a part of the second end 102 of the cable 100. The first protective sheath 800 may be used to protect the second male connector 500, the second circuit board 300, and the part of the second end 102 of the cable 100. In this way, a connection between the second male connector 500 and the second circuit board 300 is more stable, and a connection between the second circuit board 300 and the second end 102 of the cable 100 is more stable.

For example, a material of each of the first protective sheath 800 and the second protective sheath 900 may be thermoplastic polyurethanes (Thermoplastic polyurethanes, TPU) or thermoplastic elastomer (Thermoplastic Elastomer, TPE). In this way, the first protective sheath 800 and the second protective sheath 900 have relatively great strength and relatively high excellent bending resistance.

The structure of the cable assembly 1000 is described above in detail with reference to related accompanying drawings. A structure of the cable 100 is described below in detail with reference to related accompanying drawings.

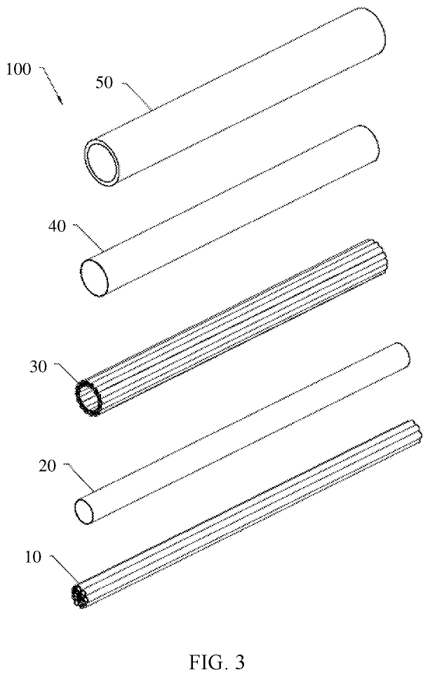

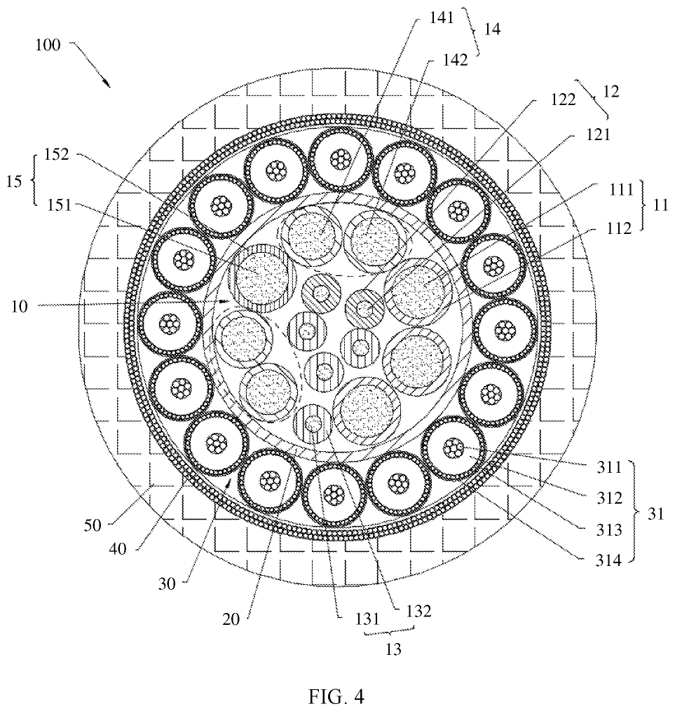

Refer to FIG. 3 and FIG. 4. FIG. 3 is a schematic exploded diagram of the cable 100 of the cable assembly 1000 shown in FIG. 2. FIG. 4 is a schematic sectional diagram of the cable 100, cut along a line A-A, in the cable assembly 1000 shown in FIG. 2. The cable 100 includes an inner wire group 10, a wrapping layer 20, an outer wire group 30, a shield layer 40, and a protective layer 50. The inner wire group 10 refers to a group of wires including a type of electronic wire. The outer wire group 30 refers to another group of wires including another type of electronic wire. Specifically, descriptions are provided below with reference to the related accompanying drawings. Details are not provided herein again.

The inner wire group 10 is surrounded by and wrapped in the wrapping layer 20. In this case, the inner wire group 10 is on an inner side of the wrapping layer 20.

In addition, the outer wire group 30 is on a side that is of the wrapping layer 20 and that is away from the inner wire group 10. It can be understood that the wrapping layer 20 may separate the inner wire group 10 from the outer wire group 30.

In addition, the shield layer 40 is on a side that is of the outer wire group 30 that is away from the wrapping layer 20. The outer wire group 30 is surrounded by and wrapped in the shield layer 40. In this case, the shield layer 40 is disposed around the wrapping layer 20.

In addition, the protective layer 50 is on a side that is of the shield layer 40 and that is away from the outer wire group 30. In this case, the shield layer 40 is between the protective layer 50 and the wrapping layer 20. The shield layer 40 is surrounded by and wrapped in the protective layer 50. In this case, the protective layer 50 is also disposed around the wrapping layer 20. It can be understood that the protective layer 50 may wrap up the outer wire group 30 on the wrapping layer 20 by using the shield layer 40. In addition, the shield layer 40 and the protective layer 50 may separate the outer wire group 30 from an outside of the cable 100.

In this embodiment, layers of various parts of the cable 100 are clear. In terms of use of the cable 100, user actions are facilitated. In terms of assembly of the cable 100, a user is facilitated for differentiation.

In another embodiment, the cable 100 may alternatively not include the shield layer 40.

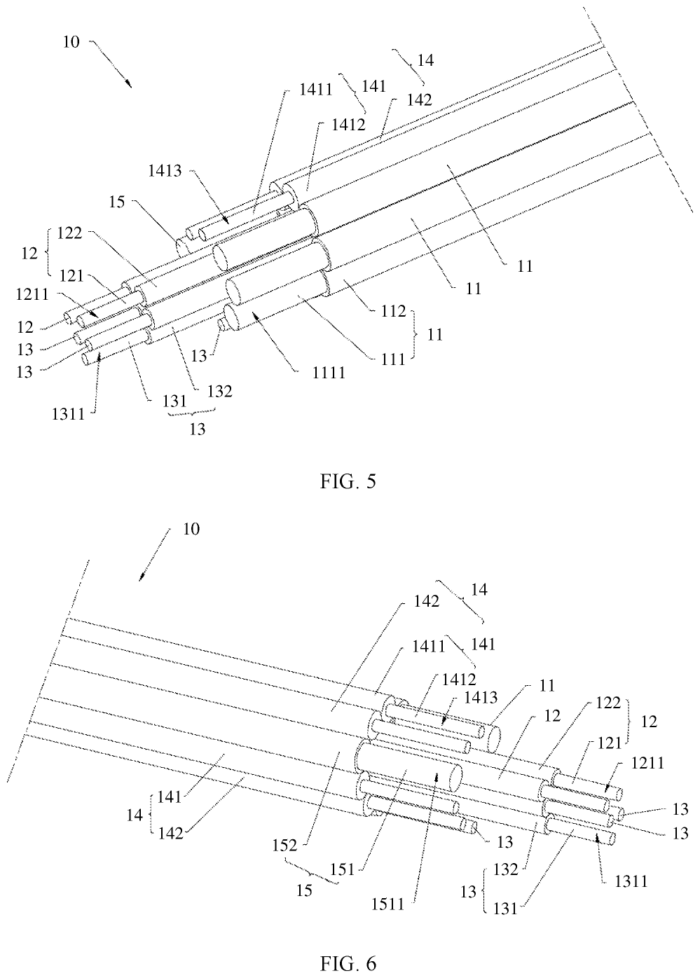

Refer to FIG. 5 and FIG. 6 with reference to FIG. 4. FIG. 5 is a schematic diagram of a partial structure of the inner wire group 10 shown in FIG. 3 at an angle. FIG. 6 is a schematic diagram of a partial structure of the inner wire group 10 shown in FIG. 3 at another angle. The inner wire group 10 includes a power wire 11, a signal wire 12, an electronic wire 13, a USB data wire set 14, and a ground wire 15. The signal wire 12 and the USB data wire set 14 are used to transmit a low-speed signal. The low-speed signal may be a signal transmitted at a rate lower than 1 Gbps. For example, the low-speed signal may be a USB 1.1 signal, a USB 2.0 signal, a Cat 5 cable signal, or the like. The ground wire 15 is used for a return circuit of the power wire 11. The electronic wire 13 is used for transmitting a low-speed signal or transmitting electric power, or is used for grounding, or is reserved (reserved, RSV). In other words, the electronic wire 13 may be used as a signal wire for transmitting a low-speed signal, the electronic wire 13 may be used as a power wire for transmitting electric power, the electronic wire 13 may be used as a ground wire, or the electronic wire 13 may be used as a backup electronic wire.

It should be understood that, for the backup electronic wire, when the electronic wire 13 is not used, a function of the electronic wire 13 is not enabled: or when the electronic wire 13 is used, a function of the electronic wire 13 is enabled. In this case, the electronic wire 13 may be used to transmit a low-speed signal or transmit electric power, or used for grounding. For example, with reference to FIG. 2, when the electronic wire 13 is reserved for use, two ends of the electronic wire may be fixedly connected to the first circuit board 200 and the second circuit board 300 and are electrically connected to the first circuit board 200 and the second circuit board 300 respectively, but the two ends of the electronic wire are not electrically connected to the first male connector 400) and the second male connector 500. When the electronic wire 13 needs to be used, the two ends of the electronic wire 13 are electrically connected to the first male connector 400 and the second male connector 500 respectively through the first circuit board 200 and the second circuit board 300. In this case, the electronic wire 13 may be used to transmit a low-speed signal or transmit electric power, or used for grounding.

In the embodiments of FIG. 4 to FIG. 6, three power wires 11 are shown merely as an example. There are two signal wires 12. There are four electronic wires 13 (and the four electronic wires 13 are RSV1, RSV2, RSV3, and RSV4 respectively). There are two USB data wire sets 14. There is one ground wire 15. In FIG. 4, the USB data wire sets 14 are marked by using a dashed line to distinguish the wire sets from another electronic wire. In another embodiments, quantities of the power wire 11, the signal wire 12, the electronic wire 13, the USB data wire set 14, and the ground wire 15 are not limited to the quantities shown in FIG. 4 to FIG. 6. The specific quantities are not limited.

It should be noted that, in the embodiments, there are three power wires 11. Each of the power wires 11 has a same shape and size. Each of the power wires 11 may use a same reference number. In both FIG. 5 and FIG. 6, three power wires 11 are shown in corresponding positions. In addition, a sectional structure of each power wire 11 in FIG. 4 can be clearly distinguished from that of another electronic wire. For brevity of the accompanying drawings, only one power wire 11 is marked in FIG. 4. In another embodiment, each of the power wires 11 may alternatively have a different shape and size. Each of the power wires 11 may alternatively use a different reference number. For a manner of providing a reference number to the signal wires 12, the electronic wires 13, the USB data wire sets 14, and the ground wire 15, refer to the manner of providing the reference number to the power wires 11. Details are not provided herein again.

Components of the inner wire group 10 are described above with reference to the accompanying drawings. A specific structure of each part is described below in detail with reference to related accompanying drawings. First, a structure of each power wire 11 is described below in detail with reference to related accompanying drawings. It should be understood that, because the three power wires 11 in the embodiments have a same structure, one of the power wires 11 is described below as an example. In addition, when there is more than one component, one component is used as an example for description. Details are not provided below again.

Refer to FIG. 5 again with reference to FIG. 4. The power wire 11 includes a power inner conductor 111 and a power insulation layer 112. A lateral surface 1111 of the power inner conductor 111 is wrapped in the power insulation layer 112. In this case, the power inner conductor 111 is on an inner side of the power insulation layer 112.

In the embodiments, the power wire 11 may be a 23 AWG FEP insulating electronic wire. The 23 AWG FEP insulating electronic wire means that a diameter of the power inner conductor 111 satisfies 23 AWG (American wire gauge, American wire gauge) (with a tolerable bias, for example, 22.7 AWG, 22.9 AWG, 23.1 AWG, or 23.2 AWG). A material of the power insulation layer 112 may be fluorinated ethylene propylene (fluorinated ethylene propylene, FEP). In this way, the power wire 11 can implement a 5A current-carrying function. When an operating voltage is 20 V, each power wire 11 can implement a function of carrying a current of 100 W. As there are three power wires 11, the three power wires 11 can implement a function of carrying a current of 300 W. When an operating voltage is 48 V, each power wire 11 can implement a function of carrying a current of 240 W. As there are three power wires 11, the three power wires 11 can implement a function of carrying a current of 720 W. Therefore, the cable 100 can transmit electric power with a power ranging from 300 W to 720 W. That is, the cable 100 can transmit high-power electric power.

In another embodiment, a range of a transmission power of the cable 100 is not specifically limited.

In another embodiment, the power inner conductor 111 may be an electronic wire of another material. In addition, a diameter of the power inner conductor 111 may be that of an electronic wire of another size. This is not specifically limited in this application.

In the embodiments, the power inner conductor 111 includes one wire. In another embodiment, the power inner conductor 111 may include a plurality of wires. The plurality of wires may be twisted with each other to form a whole.

In another embodiment, the material of the power insulation layer 112 may also be TPU or TPE. In this way, the power insulation layer 112 may have relatively great strength and relatively high excellent bending resistance.

In this embodiment, the power wires 11 can conform to UL 758 and UL 1581. In this way, quality and safety of the power wires 11 are higher, and the power wires 11 are relatively reliable.

Refer to FIG. 5 and FIG. 6 again with reference to FIG. 4. Each signal wire 12 includes a signal inner conductor 121 and a signal insulation layer 122. A lateral surface 1211 of the signal inner conductor 121 of the signal wire 12 is wrapped in the signal insulation layer 122 of the signal wire 12. In this case, the signal inner conductor 121 of the signal wire 12 is on an inner side of the signal insulation layer 122 of the signal wire 12.

In the embodiments, the signal inner conductor 121 of the signal wire 12 includes one wire. In another embodiment, the signal inner conductor 121 of the signal wire 12 may include a plurality of wires. The plurality of wires may be twisted with each other to form a whole.

In the embodiments, the signal wires 12 can conform to UL 758 and UL 1581. In this way, quality and safety of the signal wires 12 are higher, and the signal wires 12 are relatively reliable.

In another embodiment, the signal wires 12 may be electronic wires of another type.

In the embodiments, the signal wire 12 is used as a sideband link (sideband link, SL). The SL can implement high-speed link initialization, high-bandwidth digital content protection (high-bandwidth digital content protection, HDCP) handshake, capability obtaining, audio return, and the like. The two signal wires 12 are used as SL1 and SL2 respectively.

In another embodiment, the signal wires 12 may alternatively be used to implement another function. This is not specifically limited in embodiments.

Refer to FIG. 5 and FIG. 6 again with reference to FIG. 4. Each electronic wire 13 includes a signal inner conductor 131 and a signal insulation layer 132. A lateral surface 1311 of the signal inner conductor 131 of the electronic wire 13 is wrapped in the signal insulation layer 132 of the electronic wire 13. In this case, the signal inner conductor 131 of the electronic wire 13 is on an inner side of the signal insulation layer 132 of the electronic wire 13.

In the embodiments, the signal inner conductor 131 of the electronic wire 13 includes one wire. In another embodiment, the signal inner conductor 131 of the electronic wire 13 may include a plurality of wires. The plurality of wires may be twisted with each other to form a whole.

In the embodiments, an electronic wire index of the electronic wires 13 can conform to UL 758 and UL 1581. In this way, quality and safety of the electronic wires 13 are higher, and the electronic wires 13 are relatively reliable.

In another embodiment, the electronic wires 13 may be electronic wires of another type.

Refer to FIG. 5 and FIG. 6 again with reference to FIG. 4. Each USB data wire set 14 includes a first data wire 141 and a second data wire 142. The first data wire 141 and the second data wire 142 are disposed as insulating. The first data wire 141 and the second data wire 142 may be used as USB 2.0 data channels (USB Data Minus/Data Positive, D+/D−). In this case, the USB data wire set 14 is used to transmit a USB 2.0 signal.

For example, the first data wire 141 and the second data wire 142 may be twisted with each other to form twisted-pair.

Refer to FIG. 5 and FIG. 6 again. The first data wire 141 includes a data wire inner conductor 1411 and a data wire insulation layer 1412. A lateral surface 1413 of the data wire inner conductor 1411 is wrapped in the data wire insulation layer 1412. In this case, the data wire inner conductor 1411 is on an inner side of the data wire insulation layer 1412.

In the embodiments, the data wire inner conductor 1411 includes one wire. In another embodiment, the data wire inner conductor 1411 may include a plurality of wires. The plurality of wires may be twisted with each other to form a whole.

In the embodiments, the first data wire 141 can conform to UL 758 and UL 1581. In this way, quality and safety of the first data wire 141 are higher, and the first data wire 141 is relatively reliable.

In another embodiment, the first data wire 141 may be an electronic wire of another type.

In the embodiments, a structure of the second data wire 142 is the same as a structure of the first data wire 141. In this way, a structure of the USB data wire set 14 is relatively uncomplicated. In another embodiment, a structure of the second data wire 142 may alternatively be different from a structure of the first data wire 141.

In another embodiment, the USB data wire set 14 may alternatively include a data wire wrapping layer (not shown in the figures). The data wire wrapping layer is used to wrap up the first data wire 141 and the second data wire 142. In this case, the first data wire 141 and the second data wire 142 are on an inner side of the data wire wrapping layer. The data wire wrapping layer can protect the first data wire 141 and the second data wire 142. For example, a material of the data wire wrapping layer may be aluminum film or aluminum foil.

In another embodiment, the first data wire 141 and the second data wire 142 may use a structure of a coaxial wire.

Refer to FIG. 4 and FIG. 6 again. The ground wire 15 includes a grounding inner conductor 151 and a grounding insulation layer 152. A lateral surface 1511 of the grounding inner conductor 151 is wrapped in the grounding insulation layer 152. In this case, the grounding inner conductor 151 is on an inner side of the grounding insulation layer 152.

In the embodiments, the grounding inner conductor 151 includes one wire. In another embodiment, the grounding inner conductor 151 may include a plurality of wires. The plurality of wires are twisted with each other to form a whole.

In the embodiments, the ground wire 15 is a ground wire for the power wires 11. The ground wire 15 may be a 23 AWG FEP insulating electronic wire. The ground wire 15 can implement a 5A current-carrying function. In another embodiment, the ground wire 15 may be an electronic wire of another type.

In the embodiments, the ground wire 15 can conform to UL 758 and UL 1581. In this way, quality and safety of the ground wire 15 are higher, and the ground wire 15 is relatively reliable.

In the embodiments, the ground wire 15 is used for grounding. For example, grounding may be implemented by electrically connecting two ends of the ground wire 15 to grounding poles of the first circuit board 200 and the second circuit board 300.

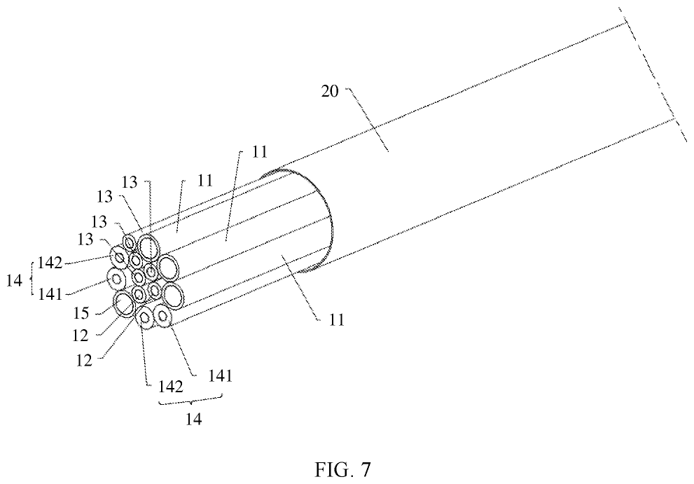

Refer to FIG. 7 with reference to FIG. 4. FIG. 7 is a schematic diagram of a partial structure of the cable 100 shown in FIG. 2. The wrapping layer 20 of the cable 100 is disposed around the three power wires 11, the two signal wires 12, the four electronic wires 13, the two USB data wire sets 14, and the one ground wire 15. The wrapping layer 20 of the cable 100 is used to wrap up the three power wires 11, the two signal wires 12, the four electronic wires 13, the two USB data wire sets 14, and the one ground wire 15. In this case, the power wires 11, the signal wires 12, the electronic wires 13, the USB data wire sets 14, and the ground wire 15 are all on the inner side of the wrapping layer 20.

It can be understood that the power wires 11, the signal wires 12, the electronic wires 13, the USB data wire sets 14, and the ground wire 15 are wrapped in the wrapping layer 20, so that the inner wire group 10 can form a relatively full circle, and the power wires 11, the signal wires 12, the electronic wires 13, the USB data wire sets 14, and the ground wire 15 can be more compact and solid. Inner space utilization of the cable 100 is further improved.

For example, a material of the wrapping layer 20 may be insulating paper. The insulating paper is relatively inexpensive. Therefore, costs of the wrapping layer 20 do not greatly increase costs of the cable 100.

For example, a material of the wrapping layer 20 may be a wave absorbing material. In this way, the wrapping layer 20 can relatively effectively shield a signal outside the wrapping layer 20.

For example, a material of the wrapping layer 20 may be poly tetra fluoroethylene (poly tetra fluoroethylene, PTFE) or polyethylene terephthalate (polyethylene terephthalate, PET).

Refer to FIG. 4 again. The outer wire group 30 includes a coaxial wire 31. The coaxial wire 31 is a type of signal wire with an electromagnetic shield layer. The coaxial wire 31 is used to transmit a high-speed signal. The high-speed signal may be a signal transmitted at a rate higher than or equal to 1 Gbps. For example, the high-speed signal may be a USB 3.2 signal, an HDMI 2.0 signal, or a Display Port 1.4 signal.

In this embodiment, the coaxial wire 31 is on a side that is of the wrapping layer 20 and that is away from the inner wire group 10. In other words, the coaxial wire 31 is on an outer side of the wrapping layer 20. There are one or more coaxial wires 31. In this embodiment, an example in which there are a plurality of coaxial wires is used. Specifically, there are 16 coaxial wires 31. The 16 coaxial wires 31 are disposed around the wrapping layer 20. The 16 coaxial wires 31 approximately form a ring-shaped structure. In another embodiment, a quantity of and a manner of arranging the coaxial wires 31 are not limited.

With reference to FIG. 1, the first device 2000 may transmit a high-speed differential signal to the cable 100. A maximum bandwidth for transmitting the high-speed differential signal may be 16 Gbps. In this case, every two coaxial wires 31 of the cable 100 can transmit a high-speed differential signal of 16 Gbps. In this way, a maximum value of a transmission bandwidth of the 16 coaxial wires 31 can reach 128 Gbps.

In another embodiment, a specific quantity of the coaxial wires 31 is not limited.

In another embodiment, when the maximum bandwidth for transmitting the high-speed differential signal transmitted by the first device 2000 to the cable 100 is greater than 16 Gbps, the maximum value of the transmission bandwidth of the plurality of coaxial wires 31 may be greater than 128 Gbps.

It can be understood that, when the cable 100 not only can supply high-power (the power ranges from 300 W to 720 W) electric power but also can transmit a high-speed signal (the maximum value of the transmission bandwidth may reach 128 Gbps), the power wires 11 of the cable 100 have particularly obvious interference on the coaxial wires 31 of the cable 100. For example, when the transmission bandwidth of the coaxial wires 31 is 128 Gbps, performance of electromagnetic radiation resistance (electromagnetic compatibility, EMC) of the coaxial wires 31 is relatively poor. In this case, although the coaxial wires 31 can transmit a high-speed signal, because performance of electromagnetic radiation resistance is poor, the coaxial wires 31 still cannot be used for signal transmission between two devices. In this embodiment, the plurality of coaxial wires 31 are disposed on the side that is of the wrapping layer 20 and that is away from the inner wire group 10, so that the coaxial wires 31 are separated from the power wires 11 and the ground wire 15 by using the wrapping layer 20. In this way, when the cable 100 is working, the power wires 11 and the ground wire 15 are unlikely to affect transmission performance of the coaxial wires 31. In this case, performance of electromagnetic radiation resistance of the cable 100 can be relatively greatly improved.

In addition, the plurality of coaxial wires 31 are separated from the signal wires 12, the electronic wires 13, and the USB data wire sets 14 by using the wrapping layer 20, so that when the cable 100 is working, signal crosstalk is unlikely to happen between the coaxial wires 31 and the signal wires 12, the electronic wires 13, and the USB data wire sets 14. In other words, the signal wires 12, the electronic wires 13, and the USB data wire sets 14 are unlikely to further affect transmission performance of the coaxial wires 31. In this way, performance of crosstalk resistance of the cable 100 can be further improved.

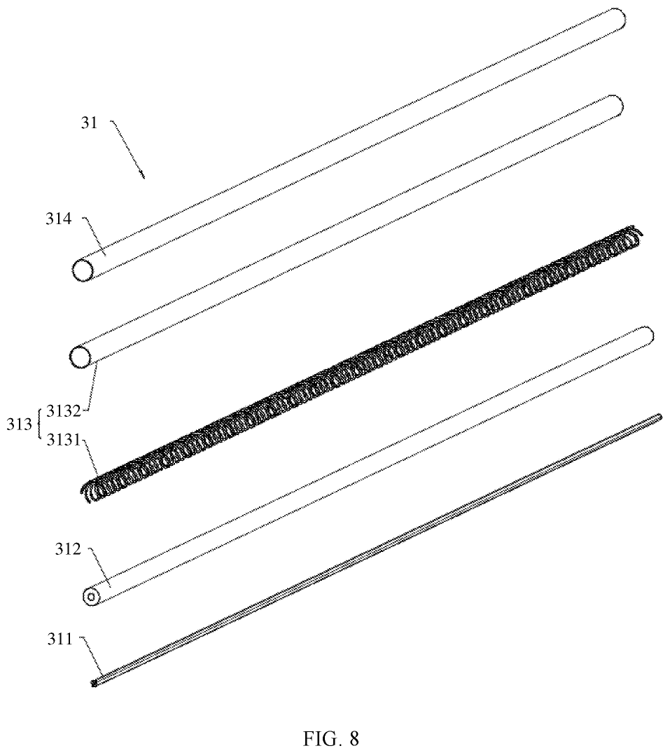

Refer to FIG. 8. FIG. 8 is a schematic exploded diagram of the coaxial wires 31 shown in FIG. 4. Each coaxial wire 31 includes at least one core wire 311, a coaxial wire insulation layer 312, a coaxial wire shield layer 313, and a rubber sheath layer 314. There are one or more core wires 311. When there is more than one core wire 311, the core wires 311 are electrically connected to each other. That is, the core wires 311 are mutually conducting. The core wires 311 are mainly used to transmit a high-speed signal.

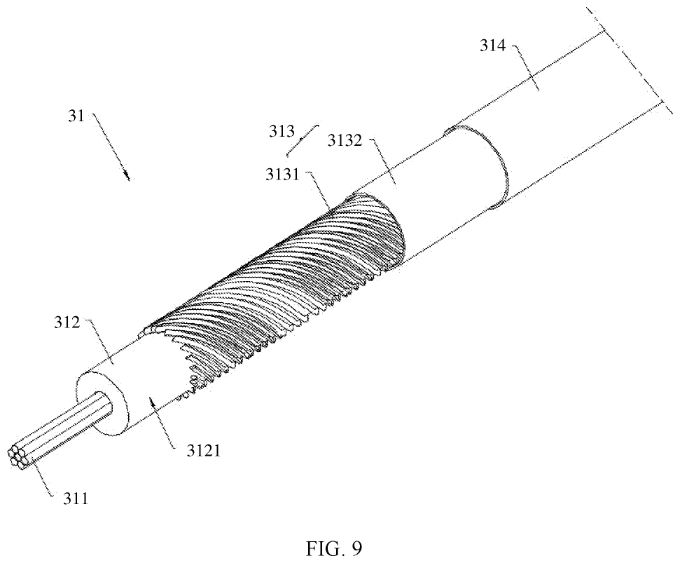

Refer to FIG. 9 with reference to FIG. 8. FIG. 9 is a schematic diagram of a partial structure of the coaxial wires 31 shown in FIG. 4. For example, there are seven core wires 311. Two adjacent core wires 311 are in contact and is electrically connected to each other.

In the embodiments, the core wires 311 are silver-coated copper wires. The seven silver-coated copper wires are twisted together to form one core wire 311. In this way, signal attenuation is relatively minor during signal transmission through the core wires 311.

In another embodiment, the core wires 311 may be electronic wires of another type. A quantity of the core wires 311 may alternatively be another value. This is not limited in this application.

Refer to FIG. 9 again with reference to FIG. 8. The coaxial wire insulation layer 312 is disposed around each core wire 311. The core wire 311 is wrapped in the coaxial wire insulation layer 312. In this case, the core wire 311 is on an inner side of the coaxial wire insulation layer 312. The coaxial wire insulation layer 312 not only can prevent an electrical connection between core wires 311 of two adjacent coaxial wires 31, but also can protect the core wire 311.

In the embodiments, the material of the coaxial wire insulation layer 312 may be FEP. In this way, the coaxial wire insulation layer 312 has high abrasive resistance and great tensile strength. In another embodiment, the coaxial wire insulation layer 312 may alternatively be made of another insulating material.

Refer to FIG. 9 again with reference to FIG. 8. The coaxial wire shield layer 313 is disposed around the coaxial wire insulation layer 312. A lateral surface 3121 of the coaxial wire insulation layer 312 is wrapped in the coaxial wire shield layer 313. In this case, the core wire 311 is on an inner side of the coaxial wire shield layer 313. The coaxial wire shield layer 313 can shield a signal outside the core wire 311 (for example, signals transmitted through the signal wires 12, the electronic wires 13, and the USB data wire sets 14), to avoid signal crosstalk on the core wire 311. Clearly, this is a better manner of design for the coaxial wires 31 for transmitting a high-speed signal.

In the embodiments, the coaxial wire shield layer 313 includes a coaxial wire winding layer 3131 and a coaxial wire wrapping layer 3132.

The coaxial wire winding layer 3131 may include a plurality of copper wires. The plurality of copper wires are wound around the lateral surface 3121 of the coaxial wire insulation layer 312. It can be understood that the coaxial wire winding layer 3131 is not limited to one layer as shown in FIG. 9. For example, the plurality of copper wires may be wound into a plurality of layers around the lateral surface 3121 of the coaxial wire insulation layer 312.

In addition, the coaxial wire winding layer 3131 is wrapped in the coaxial wire wrapping layer 3132. In this case, the coaxial wire winding layer 3131 is between the coaxial wire insulation layer 312 and the coaxial wire wrapping layer 3132. The coaxial wire wrapping layer 3132 can improve a capability of crosstalk resistance of the coaxial wires 31. In addition, the coaxial wire wrapping layer 3132 can improve firmness of a connection between the coaxial wire winding layer 3131 and the coaxial wire insulation layer 312.

For example, a material of the coaxial wire wrapping layer 3132 may be copper foil.

In another embodiment, the coaxial wire shield layer 313 may alternatively have another structure.

Refer to FIG. 9 again with reference to FIG. 8. The rubber sheath layer 314 of the coaxial wire 31 is disposed around the coaxial wire wrapping layer 3132 of the coaxial wire shield layer 313. The coaxial wire wrapping layer 3132 of the coaxial wire shield layer 313 is wrapped in the rubber sheath layer 314. In this case, the coaxial wire shield layer 313 is between the rubber sheath layer 314 and the coaxial wire insulation layer 312. The rubber sheath layer 314 is used to protect the coaxial wire shield layer 313, the coaxial wire insulation layer 312, and the core wire 311.

In the embodiments, the material of the rubber sheath layer 314 is TPU or TPE. In this way, the rubber sheath layer 314 may have relatively great strength and relatively high excellent bending resistance.

In another embodiment, the rubber sheath layer 314 may alternatively be made of another material.

A specific structure of the coaxial wires 31 is described above in detail with reference to the related accompanying drawings. A structure of another part of the cable 100 is described below with reference to related accompanying drawings.

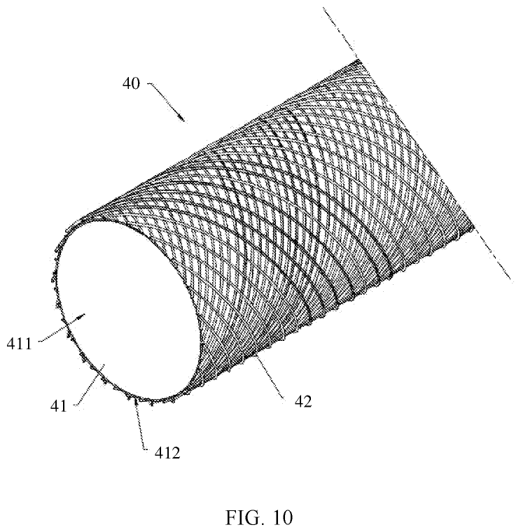

Refer to FIG. 10 with reference to FIG. 4. FIG. 10 is a schematic diagram of a structure of the shield layer 40 of the cable 100 shown in FIG. 3. The shield layer 40 of the cable 100 includes a substrate 41 and a plurality of shield wires 42.

The substrate 41 includes an inner ring surface 411 and an outer ring surface 412. The outer ring surface 412 of the substrate 41 is a surface that is of the substrate 41 and that faces the protective layer 50. The substrate 41 approximately forms a ring-shaped structure. The plurality of shield wires 42 are disposed on the outer ring surface 412 of the substrate 41. In this case, the plurality of shield wires 42 are on an outer side of the substrate 41. For example, the plurality of shield wires 42 may be formed on the outer ring surface 412 of the substrate 41 by winding, weaving, or the like. It should be noted that a quantity of layers formed by using the plurality of shield wires 42 on the outer ring surface 412 of the substrate 41 is not limited to two layers as shown in FIG. 10. For example, one layer or more than two layers may alternatively be formed. In addition, density of the plurality of shield wires 42 on the outer ring surface 412 of the substrate 41 may further be flexibly designed based on a requirement.

In another embodiment, the shield layer 40 of cable 100 may alternatively have another structure.

In the embodiments, the substrate 41 may be aluminum foil. The shield wires 42 may be copper wires. In this way, costs of the shield layer 40 of the cable 100 do not greatly increase the costs of the cable 100. In another embodiment, the substrate 41 and the shield wires 42 may alternatively be made of other materials. For example, the substrate 41 may be made of copper foil or a wave absorbing material.

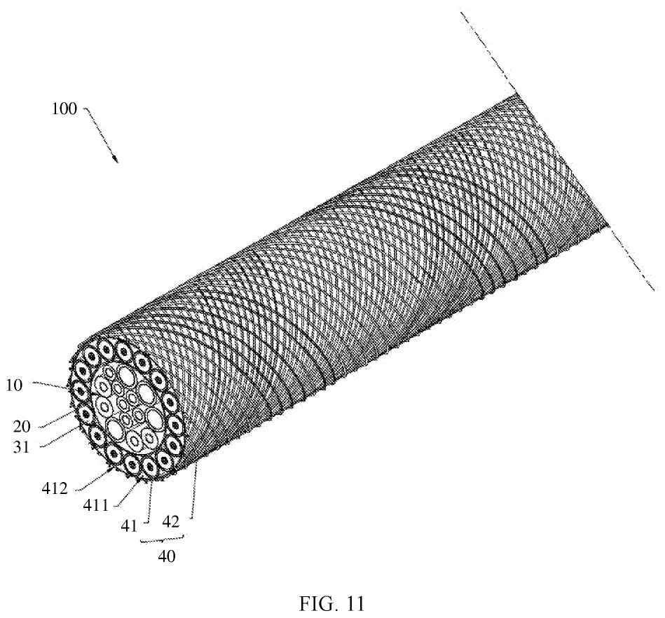

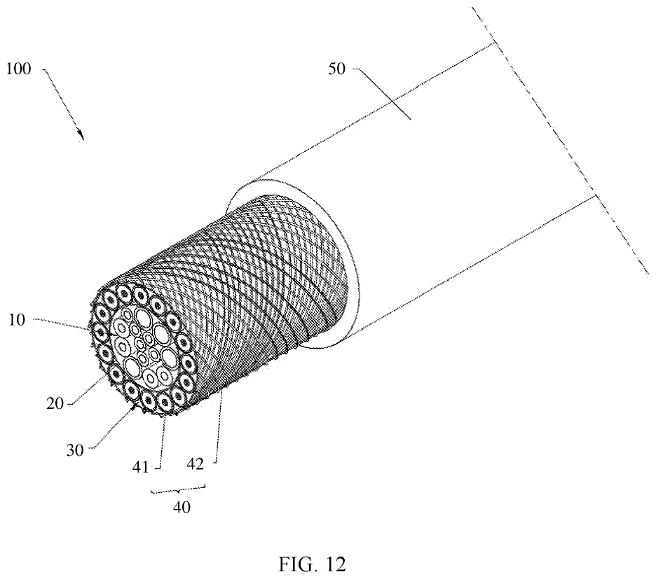

Refer to FIG. 11 with reference to FIG. 10. FIG. 11 is a schematic diagram of a partial structure of the cable 100 shown in FIG. 2. The substrate 41 of the shield layer 40 of the cable 100 wraps up the plurality of coaxial wires 31 on the wrapping layer 20. The substrate 41 is disposed around the plurality of coaxial wires 31 and the wrapping layer 20. The inner ring surface 411 of the substrate 41 is in contact with the plurality of coaxial wires 31. In this case, the plurality of coaxial wires 31 are between the substrate 41 and the wrapping layer 20 of the cable 100. The shield wires 42 are on a side that is of the substrate 41 and that is away from the coaxial wires 31.

It can be understood that the shield layer 40 of the cable 100 may separate the plurality of coaxial wires 31 from an outside of the cable 100. The shield layer 40 of the cable 100 can shield a signal outside the cable 100, to avoid crosstalk between the signal outside the cable 100 and a signal through the coaxial wires 31. In addition, the shield layer 40 of the cable 100 can further shield an electromagnetic wave outside the cable 100, to avoid interference of the electromagnetic wave outside the cable 100 on the coaxial wires 31. Clearly, this is a better manner of design for the coaxial wires 31 for transmitting a high-speed signal.

In addition, the shield layer 40 of the cable 100 further functions to fix the coaxial wires 31. In an assembly process of the cable 100, the substrate 41 of the shield layer 40 of the cable 100 may first wrap up the plurality of coaxial wires 31 on the side that is of the wrapping layer 20 and that is away from the inner wire group 10. In this case, the shield wires 42 of the shield layer 40 of the cable 100 are then wound around the outer ring surface 412 of the substrate 41. In this way, the plurality of coaxial wires 31 can be fixedly connected relatively firmly between the wrapping layer 20 of the cable 100 and the shield layer 40 of the cable 100.

In the embodiments, compared with a solution in which various parts of electronic wires in the inner wire group 10 are mixed up with the plurality of coaxial wires 31 for assembly, the embodiments provide the coaxial wires 31 that can be assembled separately. In an assembly process, a problem that various electronic wires move relative to each other, the coaxial wires 31 cannot be easily wrapped in the shield layer 40 of the cable 100, and assembly of the cable 100 is more difficult because the coaxial wires 31 and the power wires 11, the signal wires 12, the electronic wires 13, the USB data wire sets 14, and the ground wire 15 are mixed up does not emerge. Therefore, the cable 100 in the embodiments relatively has high manufacturability. In addition, each coaxial wire 31 has an approximately same size and shape. In this case, the coaxial wires 31 can be relatively arranged compactly and solidly. In this way, an inner space of the cable 100 can be utilized to a relatively large extent.

Refer to FIG. 12 with reference to FIG. 11. FIG. 12 is a schematic diagram of a partial structure of the cable 100 shown in FIG. 2. The protective layer 50 of the cable 100 is disposed around the shield layer 40 of the cable 100, and wraps up the shield layer 40 of the cable 100. The protective layer 50 can protect the shield layer 40, the outer wire group 30, and the inner wire group 10 of the cable 100 from being damaged by a component outside the cable 100. In addition, the protective layer 50 is further convenient for a user in use. For example, the cable 100 may be coiled up.

The material of the protective layer 50 may also be TPU or TPE. In this way, the protective layer 50 may have relatively great strength and relatively high excellent bending resistance.

In another embodiment, the protective layer 50 may alternatively be made of another material.

The structure of the cable 100 is described above in detail with reference to the related accompanying drawings. The cable 100 not only can transmit high-power electric power, but also can transmit a high-speed signal. Specifically, the cable 100 includes the three power wires 11, where the diameter of the power inner conductor 111 of each power wire 11 satisfies 23 AWG, and the material of the power insulation layer 112 of each power wire 11 is FEP. In this way, the cable 100 can implement a current-carrying function with a power ranging from 300 W to 720 W. That is, the cable 100 can transmit high-power electric power. In addition, the cable 100 includes the 16 coaxial wires 31, where every two coaxial wires 31 can transmit a high-speed differential signal of 16 Gbps. In this way, the transmission bandwidth of the 16 coaxial wires 31 can reach 128 Gbps. Therefore, the cable 100 can transmit a high-speed signal. It can be understood that, when the cable 100 not only can supply high-power electric power but also can transmit a high-speed signal, the power wires 11 of the cable 100 have particularly obvious interference on the coaxial wires 31 of the cable 100. Consequently, performance of electromagnetic radiation resistance of the cable 100 is relatively poor. In this case, although the coaxial wires 31 can transmit a high-speed signal, because performance of electromagnetic radiation resistance is poor, the coaxial wires 31 still cannot be used for signal transmission between two devices. In the cable 100 in the embodiments, the coaxial wires 31 are separated from the power wires 11 by using the wrapping layer 20. Therefore, when a signal is transmitted through the cable 100, transmission performance of the coaxial wires 31 is unlikely to be affected by the power wires 11. In this way, the cable 100 can still supply high-power electric power and transmit a high-speed signal, and performance of electromagnetic radiation resistance of the cable 100 can be greatly improved.

In addition, when the cable 100 not only can supply high-power electric power but also can transmit a high-speed signal, another electronic wire of the cable 100 have particularly obvious interference on the signal through the coaxial wires 31 of the cable 100. Consequently, performance of crosstalk resistance of the cable 100 is relatively poor. In this case, although the coaxial wires 31 can transmit a high-speed signal, because performance of crosstalk resistance is poor, the coaxial wires 31 still cannot be used for signal transmission between two devices. The cable 100 in the embodiments relatively has better performance of crosstalk resistance.

Specifically, the coaxial wires 31 are separated from the signal wires 12, the electronic wires 13, and the USB data wire sets 14 by using the wrapping layer 20. Therefore, when a signal is transmitted through the cable 100, signal crosstalk is unlikely to happen between the coaxial wires 31 and the signal wires 12, the electronic wires 13, and the USB data wire sets 14.

In addition, the plurality of coaxial wires 31 are wrapped in the shield layer 40 of the cable 100, so that an effect of the signal outside the cable 100 on transmission performance of the coaxial wires 31 is avoided, that is, crosstalk is unlikely to happen between the signal outside the cable 100 and the signal through the coaxial wires 31.

Finally, each coaxial wire 31 is provided with the coaxial wire shield layer 313, so that the coaxial wire shield layer 313 can avoid effect of an external signal on the core wire 311 of the coaxial wire 31, to avoid effect of the signal wires 12, the electronic wires 13, the USB data wire sets 14, and the signal outside the cable 100 on transmission performance of the coaxial wires 31.

In addition, the cable 100 in the embodiments can further solve some problems of a structure of a conventional cable.

First, in this application, the inner wire group 10 is wrapped by using the wrapping layer 20, so that the inner wire group 10 approximately forms a full circle. The power wires 11, the signal wires 12, the electronic wires 13, the USB data wire sets 14, and the ground wire 15 can be more compact and solid, facilitating implementing a design of a smaller outer diameter of the cable 100.

Second, compared with a solution in which various parts of electronic wires in the inner wire group 10 are mixed up with the plurality of coaxial wires 31 for assembly, the embodiments provide the coaxial wires 31 that can be assembled separately. In an assembly process, a problem that various wires move relative to each other, the coaxial wires 31 cannot be easily wrapped in the shield layer 40 of the cable 100, and assembly of the cable 100 is more difficult because the coaxial wires 31 and the power wires 11, the signal wires 12, the electronic wires 13, the USB data wire sets 14, and the ground wire 15 are mixed up does not emerge. Therefore, the cable 100 in the embodiments relatively has high manufacturability. In addition, each coaxial wire 31 has an approximately same size and shape. In this case, the coaxial wires 31 can be relatively arranged compactly and solidly. In this way, an inner space of the cable 100 can be utilized to a relatively large extent.

In addition, because the coaxial wires 31 can be relatively easily wrapped in the shield layer 40 of the cable 100, the cable 100 can more easily form a full round circle. In this case, a thickness of the protective layer 50 wrapping the shield layer 40 of the cable 100 can be more easily controlled. The cable 100 can be assembled more solidly and compactly. A minimum value of the outer diameter of the cable 100 can reach 6 millimeters or even less.

Finally, a material of the wrapping layer 20 in the embodiments may be insulating paper. The insulating paper is relatively inexpensive. Therefore, costs of the wrapping layer 20 do not greatly increase costs of the cable 100 while the wrapping layer 20 can achieve the foregoing effects.

Refer to FIG. 2 again. An embodiment provides the cable assembly 1000. The cable assembly 1000 includes the first circuit board 200, the second circuit board 300, the first male connector 400, the second male connector 500, and the cable 100. The structure of the cable 100 is described above in detail. Details are not provided herein again.

The cable 100 includes the first end 101 and the second end 102. The first end 101 of the cable 100 is fixedly connected to the first circuit board 200 and is electrically connected to the first circuit board 200. The second end 102 of the cable 100 is fixedly connected to the second circuit board 300 and is electrically connected to the second circuit board 300.

The first male connector 400 is fixedly connected to the first circuit board 200, and is electrically connected to the first end 101 of the cable 100 through the first circuit board 200. The first male connector 400 is used to fit into the first female connector 600 of the first device 2000.

The second male connector 500 is fixedly connected to the second circuit board 300, and is electrically connected to the second end 102 of the cable 100 through the second circuit board 300. The second male connector 500 is used to fit into the second female connector 700 of the second device 3000.

In addition, the cable assembly 1000 further includes the first protective sheath 800 and the second protective sheath 900. The first protective sheath 800 is sleeved on a part of the first male connector 400, the first circuit board 200, and the first end 101 of the cable 100. The second protective sheath 900 is sleeved on a part of the second male connector 500, the second circuit board 300, and the second end 102 of the cable 100.

Refer to FIG. 1 and FIG. 2 again. An embodiment provides a communications system 1. The communications system 1 includes a first device 2000, a second device 3000, and a cable 100. The cable 100 is electrically connected to the first device 2000. The cable 100 is electrically connected to the second device 3000. The structure of the cable 100 is described above in detail. Details are not provided herein again.

In addition, the first device 2000 may be a set-top box. The second device 3000 may be a screen. The first device 2000 transmits electric power and a signal to the second device 3000 through the cable 100.

In addition, the cable 100 includes a first end 101 and a second end 102. The communications system 1 further includes a first circuit board 200, a second circuit board 300, a first male connector 400, and a second male connector 500. The first end 101 of the cable 100 is fixedly connected to the first circuit board 200 and is electrically connected to the first circuit board 200. The second end 102 of the cable 100 is fixedly connected to the second circuit board 300 and is electrically connected to the second circuit board 300. The first male connector 400 is fixedly connected to the first circuit board 200, and is electrically connected to the first end 101 of the cable 100 through the first circuit board 200. The second male connector 500 is fixedly connected to the second circuit board 300, and is electrically connected to the second end 102 of the cable 100 through the second circuit board 300. The first device 2000 is provided with a first female connector 600. The second device 3000 is provided with a second female connector 700. The first male connector 400 fits into the first female connector 600. The second male connector 500 fits into the second female connector 700.

In addition, the communications system 1 further includes a first protective sheath 800 and a second protective sheath 900. The first protective sheath 800 is sleeved on a part of the first male connector 400, the first circuit board 200, and the first end 101 of the cable 100. The second protective sheath 900 is sleeved on a part of the second male connector 500, the second circuit board 300, and the second end 102 of the cable 100.

Refer to FIG. 1 and FIG. 2 again. An embodiment provides a communications system 1. The communications system 1 includes a device (2000, 3000) and a cable 100. The cable 100 is electrically connected to the device (2000, 3000). The device (2000, 3000) may be the foregoing first device 2000, or may be the foregoing second device 2000. For example, the device (2000, 3000) is a screen or a set-top box.

It can be understood that the communications system 1 is a whole independent product including the cable 100 and the first device 2000. Alternatively, the communications system 1 in this embodiment is a whole independent product including the cable 100 and the second device 2000. For example, the cable 100 and a set-top box form an independent product. The cable 100 and a screen form an independent product.

In addition, the cable 100 includes a first end 101 and a second end 102. The communications system 1 further includes a first circuit board 200, a second circuit board 300, a first male connector 400, and a second male connector 500. The first end 101 of the cable 100 is fixedly connected to the first circuit board 200 and is electrically connected to the first circuit board 200. The second end 102 of the cable 100 is fixedly connected to the second circuit board 300 and is electrically connected to the second circuit board 300. The first male connector 400 is fixedly connected to the first circuit board 200, and is electrically connected to the first end 101 of the cable 100 through the first circuit board 200. The second male connector 500 is fixedly connected to the second circuit board 300, and is electrically connected to the second end 102 of the cable 100 through the second circuit board 300.

The cable 100 is electrically connected to the device (2000, 3000) by using the first male connector 400. Alternatively, the cable 100 is electrically connected to the device (2000, 3000) by using the second male connector 500.

In addition, the communications system 1 further includes a first protective sheath 800 and a second protective sheath 900. The first protective sheath 800 is sleeved on a part of the first male connector 400, the first circuit board 200, and the first end 101 of the cable 100. The second protective sheath 900 is sleeved on a part of the second male connector 500, the second circuit board 300, and the second end 102 of the cable 100.

Refer to FIG. 3 and FIG. 12 again. An embodiment provides a cable 100. The cable 100 includes power wires 11, signal wires 12, electronic wires 13, USB data wire sets 14, a ground wire 15, a wrapping layer 20, a plurality of coaxial wires 31, a shield layer 40, and a protective layer 50. Both the signal wires 12 and the USB data wire sets 14 are used to transmit a low-speed signal. The signal wires 12 are sideband links. The electronic wires 13 are used for transmitting a low-speed signal or transmitting electric power, or is used for grounding, or is reserved. The plurality of coaxial wires 31 are used to transmit a high-speed signal. A maximum value of a transmission bandwidth of the plurality of coaxial wires 31 is 128 Gbps.

In addition, the power wires 11, the signal wires 12, the electronic wires 13, the USB data wire sets 14, and the ground wire 15 are wrapped in the wrapping layer 20. The wrapping layer 20 is insulating paper, PET, PTFE, or a wave absorbing material. The plurality of coaxial wires 31 are on an outer side of the wrapping layer 20, and the plurality of coaxial wires 31 are disposed around the wrapping layer 20 and form a ring. The shield layer 40 includes a substrate 41 and a plurality of shield wires 42. The plurality of coaxial wires 31 are wrapped in the substrate 41. The substrate 41 has an outer ring surface 412. The outer ring surface 412 of the substrate 41 is a surface that is of the substrate 41 and that is away from the wrapping layer 20. The plurality of shield wires 42 are disposed on the outer ring surface 412 of the substrate 41. The substrate 41 is aluminum foil. The shield wires 42 are copper wires. The plurality of shield wires 42 are wrapped in the protective layer 50. A material of the protective layer 50 is TPU or TPE.

It can be understood that, for structures of various parts of the cable 100, refer to the structures of various parts of the cable 100 described above. Details are not provided herein again.

Refer to FIG. 1 to FIG. 12 again. This application provides a cable assembly 1000. The cable assembly 1000 includes a first circuit board 200, a second circuit board 300, a first female connector 600, a second female connector 700, and the cable 100 described above.

The cable 100 includes a first end 101 and a second end 102. The first end 101 of the cable 100 is fixedly connected to the first circuit board 200 and is electrically connected to the first circuit board 200. The second end 102 of the cable 100 is fixedly connected to the second circuit board 300 and is electrically connected to the second circuit board 300.

The first female connector 600 is fixedly connected to the first circuit board 200, and is electrically connected to the first end 101 of the cable 100 through the first circuit board 200. The first female connector 600 is used to fit into a first male connector 400 of a first device 2000. The second female connector 700 is fixedly connected to the second circuit board 300, and is electrically connected to the second end 102 of the cable 100 through the second circuit board 300. The second female connector 700 is used to fit into a second male connector 500 of a second device 3000.

It can be understood that, in this application, the cable 100 has relatively high performance of electromagnetic resistance and high performance of crosstalk resistance, and the cable 100 can still transmit a high-speed signal. When the cable is applied to the cable assembly 1000, the cable assembly 1000 also has relatively high performance of electromagnetic resistance and high performance of crosstalk resistance, and the cable assembly 1000 can still transmit a high-speed signal.

In addition, the first circuit board 200 and the first female connector 600 are disposed at the first end 101 of the cable, the second circuit board 300 and the second female connector 700 are disposed at the second end 102 of the cable, so that the cable assembly 1000 not only can transmit electric power, but also can transmit a high-speed signal.

In a possible implementation, the cable assembly 1000 further includes a first protective sheath 800 and a second protective sheath 900. The first protective sheath 800 is sleeved on a part of the first female connector 600, the first circuit board 200, and the first end 101 of the cable. The second protective sheath 900 is sleeved on a part of the second female connector 700, the second circuit board 300, and the second end 102 of the cable. It can be understood that the first protective sheath 800 can protect the part of the first female connector 600, the first circuit board 200, and the first end 101 of the cable 100. The second protective sheath 900 can protect the part of the second female connector 700, the second circuit board 300, and the second end 102 of the cable 100.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A cable (100), comprising a power wire (11), a signal wire (12), a ground wire (15), a wrapping layer (20), a coaxial wire (31), and a protective layer (50), wherein the signal wire (12) is used to transmit a low-speed signal, and the coaxial wire (31) is used to transmit a high-speed signal:
the power wire (11), the signal wire (12), and the ground wire (15) are wrapped in the wrapping layer (20);
the coaxial wire (31) is on an outer side of the wrapping layer (20), wherein the coaxial wire (31) is separated from the power wire (11), the signal wire (12), and the ground wire (15); and
the wrapping layer (20) and the coaxial wires (31) are wrapped in the protective layer (50).

2. The cable (100) according to claim 1, wherein the wrapping layer (20) is insulating paper, PET, PTFE, or a wave absorbing material.

3. The cable (100) according to claim 1, wherein the power wire (11) comprises a power inner conductor (111) and a power insulation layer (112), and a lateral surface (1111) of the power inner conductor (111) is wrapped in the power insulation layer (112); and
a diameter of the power inner conductor (111) satisfies 23 AWG, and a material of the power insulation layer (112) is FEP.

4. The cable (100) according to claim 1, wherein the cable (100) further comprises an electronic wire (13), the electronic wire (13) is wrapped in the wrapping layer (20), and the electronic wire (13) is used for transmitting a low-speed signal or transmitting electric power, or is used for grounding, or is reserved.

5. The cable (100) according to claim 1, wherein the signal wire (12) is a sideband link.

6. The cable (100) according to claim 1, wherein the cable (100) further comprises a USB data wire set (14), wherein the USB data wire set (14) is wrapped in the wrapping layer (20); and
the USB data wire set (14) is used to transmit a low-speed signal.

7. The cable (100) according to claim 1, wherein there are a plurality of coaxial wires (31), and the plurality of coaxial wires (31) are disposed around the wrapping layer (20) and form a ring.

8. The cable (100) according to claim 1, wherein the cable (100) comprises a shield layer (40), the shield layer (40) is between the protective layer (50) and the wrapping layer (20), the shield layer (40) is disposed around the wrapping layer (20), and the shield layer (40) is used to shield a signal outside the cable (100); and
the wrapping layer (20) and the coaxial wires (31) are wrapped in the protective layer (50) with the shield layer (40).

9. The cable (100) according to claim 8, wherein the shield layer (40) comprises a substrate (41) and a plurality of shield wires (42), the substrate (41) is disposed around the wrapping layer (20), and the wrapping layer (20) and the coaxial wires (31) are wrapped in the protective layer (50) with the substrate (41); and
the substrate (41) has an outer ring surface (412), the outer ring surface (412) of the substrate (41) is a surface that is of the substrate (41) and that faces the protective layer (50), and the plurality of shield wires (42) are disposed on the outer ring surface (412) of the substrate (41).

10. The cable (100) according to claim 9, wherein the substrate (41) is aluminum foil, and the shield wires (42) are copper wires.

11. The cable (100) according to claim 1,
wherein the signal wire (12) comprises a signal inner conductor (121) and a signal insulation layer (122); and
a lateral surface (1211) of the signal inner conductor (121) of the signal wire (12) is wrapped in the signal insulation layer (122) of the signal wire (12).

12. The cable (100) according to claim 1,
wherein the coaxial wire (31) comprises at least one core wire (311), a coaxial wire insulation layer (312), a coaxial wire shield layer (313), and a rubber sheath layer (314); and
the core wire (311) is wrapped in the coaxial wire insulation layer (312), a lateral surface (3121) of the coaxial wire insulation layer (312) is wrapped in the coaxial wire shield layer (313), and the coaxial wire shield layer (313) is wrapped in the rubber sheath layer (314).

13. The cable (100) according to claim 1, wherein a material of the protective layer (50) is TPU or TPE.

14. A cable assembly (1000), comprising a first circuit board (200), a second circuit board (300), a first male connector (400), a second male connector (500), and a cable (100); wherein the cable (100) comprising a power wire (11), a signal wire (12), a ground wire (15), a wrapping layer (20), a coaxial wire (31), and a protective layer (50), wherein the signal wire (12) is used to transmit a low-speed signal, and the coaxial wire (31) is used to transmit a high-speed signal, wherein the power wire (11), the signal wire (12), and the ground wire (15) are wrapped in the wrapping layer (20), wherein the coaxial wire (31) is on an outer side of the wrapping layer (20), wherein the coaxial wire (31) is separated from the power wire (11), the signal wire (12), and the ground wire (15), and wherein the wrapping layer (20) and the coaxial wires (31) are wrapped in the protective layer (50); wherein
the cable (100) comprises a first end (101) and a second end (102), wherein the first end (101) of the cable (100) is fixedly connected to the first circuit board (200) and is electrically connected to the first circuit board (200), and the second end (102) of the cable (100) is fixedly connected to the second circuit board (300) and is electrically connected to the second circuit board (300));
the first male connector (400) is fixedly connected to the first circuit board (200), and is electrically connected to the first end (101) of the cable (100) through the first circuit board (200), and the first male connector (400) is used to fit into a first female connector (600) of a first device (2000); and
the second male connector (500) is fixedly connected to the second circuit board (300), and is electrically connected to the second end (102) of the cable (100) through the second circuit board (300), and the second male connector (500) is used to fit into a second female connector (700)) of a second device (3000).

15. The cable assembly (1000) according to claim 14, wherein the cable assembly (1000) further comprises a first protective sheath (800) and a second protective sheath (900), wherein
the first protective sheath (800) is sleeved on a part of the first male connector (400), the first circuit board (200), and the first end (101) of the cable (100), and the second protective sheath (900) is sleeved on a part of the second male connector (500), the second circuit board (300), and the second end (102) of the cable (100).

16. A communications system (1), comprising a first device (2000), a second device (3000), and a cable (100), wherein the cable (100) is electrically connected to the first device (2000), and the cable (100) is electrically connected to the second device (3000), and wherein the cable (100) comprises a power wire (11), a signal wire (12), a ground wire (15), a wrapping layer (20), a coaxial wire (31), and a protective layer (50), wherein the signal wire (12) is used to transmit a low-speed signal, and the coaxial wire (31) is used to transmit a high-speed signal, wherein the power wire (11), the signal wire (12), and the ground wire (15) are wrapped in the wrapping layer (20), wherein the coaxial wire (31) is on an outer side of the wrapping layer (20), wherein the coaxial wire (31) is separated from the power wire (11), the signal wire (12), and the ground wire (15), and wherein the wrapping layer (20) and the coaxial wires (31) are wrapped in the protective layer (50).

17. The communications system (1) according to claim 16, wherein the first device (2000) is a set-top box, the second device (3000) is a screen, and the first device (2000) transmits electric power and a signal to the second device (3000) through the cable (100).

18. The communications system (1) according to claim 16, wherein the cable (100) comprises a first end (101) and a second end (102);
the communications system (1) further comprises a first circuit board (200), a second circuit board (300), a first male connector (400), and a second male connector (500);
the first end (101) of the cable (100) is fixedly connected to the first circuit board (200) and is electrically connected to the first circuit board (200), and the second end (102) of the cable (100) is fixedly connected to the second circuit board (300) and is electrically connected to the second circuit board (300);
the first male connector (400) is fixedly connected to the first circuit board (200), and is electrically connected to the first end (101) of the cable (100) through the first circuit board (200), and the second male connector (500) is fixedly connected to the second circuit board (300), and is electrically connected to the second end (102) of the cable (100) through the second circuit board (300); and
the first device (2000) is provided with a first female connector (600), and the second device (3000) is provided with a second female connector (700), wherein the first male connector (400) fits into the first female connector (600), and the second male connector (500) fits into the second female connector (700).

19. The communications system (1) according to claim 18, wherein the communications system (1) further comprises a first protective sheath (800) and a second protective sheath (900); and
the first protective sheath (800) is sleeved on a part of the first male connector (400), the first circuit board (200), and the first end (101) of the cable (100), and the second protective sheath (900) is sleeved on a part of the second male connector (500), the second circuit board (300), and the second end (102) of the cable (100).

20-24. (canceled)

25. The communications system (1) according to claim 16, wherein the wrapping layer (20) is insulating paper, PET, PTFE, or a wave absorbing material.
